(19) United States
(12) Patent Application Publication
(10) Pub. No.: US 2006/0187176 A1
(43) Pub. Date: Aug. 24, 2006

(54) Display panels and display devices using the same

(75) Inventor: Chien-Sheng Yang, Jhudong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/113,696

(22) Filed: Apr. 25, 2005

(30) Foreign Application Priority Data
Feb. 21, 2005 (TW) 94105034

(51) Int. Cl. G09G 3/36

(52) U.S. Cl. 345/100

(57) ABSTRACT

A display panel comprising a display unit, a first scan driver, a first data driver, a second scan driver, and a second data driver. When the first scan driver turns on the display unit according to a first scan start signal, the first data driver provides a video signal related to an image to the display unit according to a first data start signal. When the second scan driver turns on the display unit according to a second scan start signal, the second data driver provides a predetermined signal to the display unit.

### BACKGROUND

The invention relates to a display device, and in particular to a display panel displaying a desired image and a single-gray-level image by using two sets of scan and data drivers, eliminating overlap.

FIG. 1 is a schematic diagram of a conventional liquid crystal display (LCD) panel. As shown in FIG. 1, the LCD panel 1 comprises a data driver 10, a scan driver 11, and a display array 12. The data driver 10 controls a plurality of data lines D₁ to Dₙ, and the scan driver 11 controls a plurality of scan lines S₁ to Sₘ. The display array 12 is formed by interlacing data lines D₁ to Dₙ and scan lines S₁ to Sₘ. The interlaced data line Dₙ and scan line Sₘ correspond to a display unit, for example, here, the interlaced data line D₁ and scan line S₁ correspond to a display unit 100. The equivalent circuit of conventional display unit 100 comprises a thin film transistor (TFT) T10, a storage capacitor Cs10, and a liquid crystal capacitor-Clc10.

The scan driver 11 sequentially outputs scan signals to scan lines S₁ to Sₘ according to a scan control signal. When receiving a scan signal, a scan line corresponding to a row turns on the TFTs within all display units corresponding to the row, while the TFTs within all display units corresponding to all other rows are turned off by other scan lines. When the TFTs within all display unit pixels corresponding to a row are all turned on, the data driver 10 outputs corresponding video signals with gray scale values to n display units corresponding to the row through the data lines D₁ to Dₘ according to image data prepared for but not yet displayed. As an example, when the scan driver 11 outputs a scan signal to the scan line S₁, the TFT T10 is turned on. The data driver 10 outputs a corresponding video signal to the display unit 100 through the data lines D₁, and the storage capacitor Cs10 stores the voltage level of the video signal. According to the voltage stored in the storage capacitor Cs10, the deflection angle of the liquid crystal molecules of the liquid crystal capacitor Clc10 can be determined, such that the amount of light from a backlight module of the LCD device can be also determined.

A hold-driving method is used to control display units of LCD devices. Referring to FIG. 2a, the illumination of a display unit is maintained at a specific level during a whole frame, such as frame F11, using the hold-driving method. In the circuitry, during the frame F11, the voltage stored in the storage capacitor Cs10 is held at a constant until the next frame F12. However, the response time of the liquid crystal molecules is lower than a frame period. When the voltage of a video signal associated with the frame F12 is first stored in the storage capacitor Cs10, the voltage of a video signal associated with the frame F11 remains. Thus, when LCD devices display dynamic images, overlap of the images occurs.

Conventional cathode ray tube (CRT) display devices determine illumination by controlling an electron beam. An impulse-driving method is used in CRT display devices, and in FIG. 2b, the relationship between time and illumination thereof is shown. The illumination is not maintained at a specific level during a whole frame. Thus, when CRT display devices display dynamic images, no overlap of images occurs.

### SUMMARY

Display panels are provided. An exemplary embodiment of a display panel displays an image and comprises a display unit, a first scan driver, a first data driver, a second scan driver, and a second data driver. The first scan driver receives a first scan start signal. The first data driver provides a video signal related to the image to the display unit according to a first data start signal when the first scan driver turns on the display unit according to the first scan start signal. The second scan driver receives a second scan start. The second data driver provides a predetermined signal to the display unit when the second scan driver turns on the display unit according to the second scan start signal.

Display devices are further provided. An exemplary embodiment of a display device displays an image and comprises a timing controller and a display panel. The timing controller provides first and second scan start signals and a first data start signal. The display panel comprises a display unit, a first scan driver, a first data driver, a second scan driver, and a second data driver. The first scan driver receives the first scan start signal. The first data driver provides a video signal related to the image to the display unit according to the first data start signal when the first scan driver turns on the display unit according to the first scan start signal. The second scan driver receives the second scan start. The second data driver provides a predetermined signal to the display unit when the second scan driver turns on the display unit according to the second scan start signal.

### DESCRIPTION OF THE DRAWINGS

The invention panels and display devices will become more fully understood from the detailed description given hereinbelow and the accompanying drawings, given by way of illustration only and thus not intended to be limitative of the invention.

FIG. 1 is a schematic diagram of a conventional LCD device.

FIG. 2a depicts the relationship between time and illumination of a conventional LCD device driven by a hold-driving method.

FIG. 2b depicts the relationship between time and illumination of a CRT display device driven by an impulse-driving method.

FIG. 3 depicts an embodiment of a display device.

FIG. 4 depicts the relationship between time and illumination of the display device in FIG. 3.

FIG. 5 depicts an embodiment of a display device.

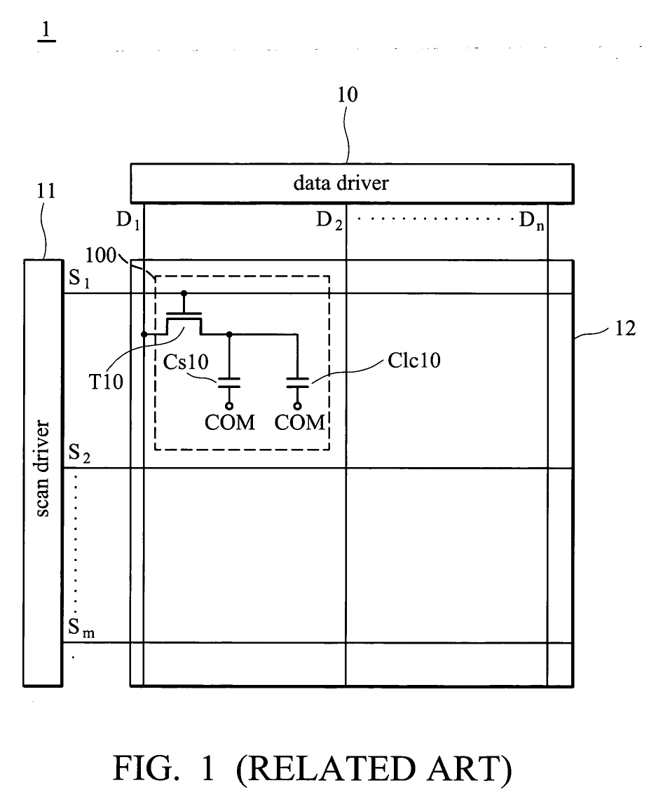

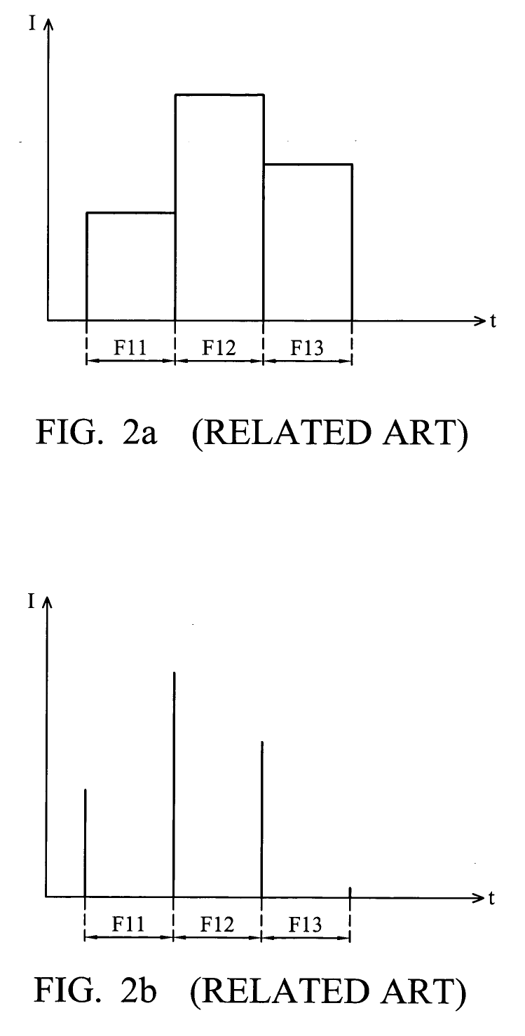

### DETAILED DESCRIPTION

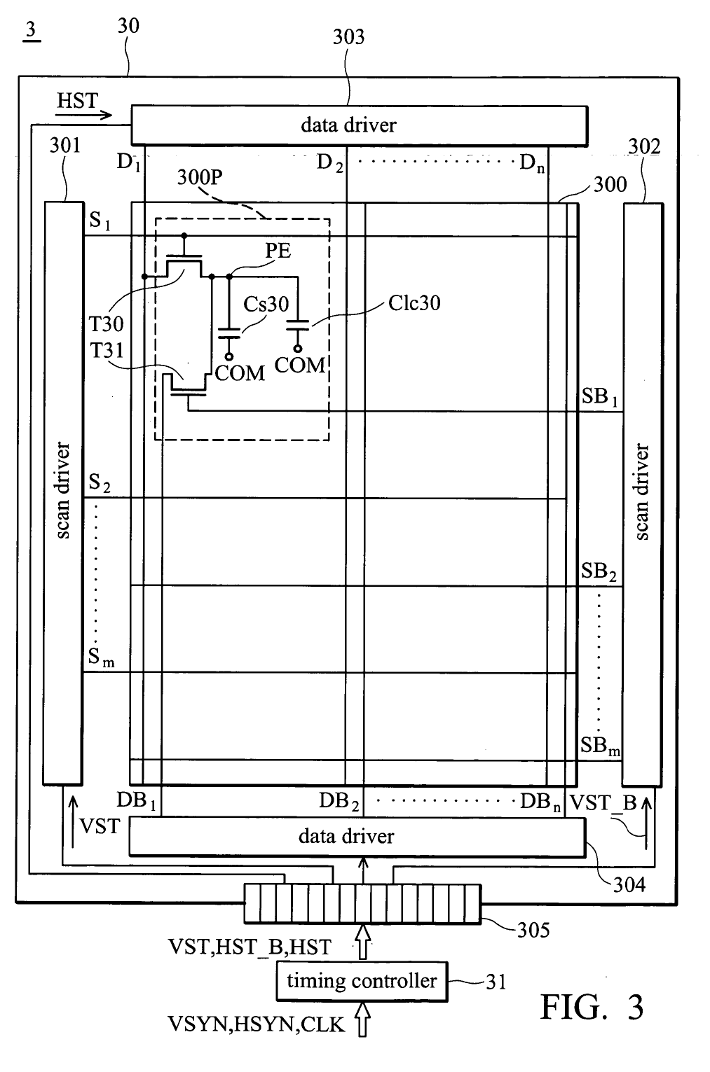

Display devices are provided. In some embodiments, as shown in FIG. 3, a display device 3 comprises a display panel 30 and timing controller 31. The exemplary embodiment of the display panel 30 comprises a display array 300, scan drivers 301 and 302, data driver 303 and 304, and an input port 305. The scan driver 301 controls a plurality of scan lines S₁ to Sₘ, while the scan driver 302 controls a plurality of scan lines SB₁ to SBₘ. The data driver 303 controls a plurality of data lines D₁ to Dₙ, while the data driver 304 controls a plurality of data lines DB₁ to DBₙ. The display array is formed by the scan lines S₁ to Sₘ and SB₁ to SBₘ and the data lines D₁ to Dₙ and DB₁ to DBₙ. The interlaced data lines and scan lines correspond to a display unit, for example, the interlaced data lines D₁ and DB₁ and scan lines S₁ and SB₁ correspond to display unit 300P. The timing controller 31 receives a vertical synchronization signal VSYN, a horizontal synchronization signal HSYN, and a clock CLK and generates vertical start signals VST and VST_B and a data start signal HST to the display panel 30.

Referring to FIG. 3, the equivalent circuit of the display unit 300P comprises two switch elements, a storage capacitor Cs30, and liquid crystal capacitor Clc30. In this embodiment, the two switch elements are respectively implemented by NMOS transistors T30 and T31. A gate of the transistor T30 is coupled to the scan line S₁, a drain thereof is coupled to the data line D₁, and a source thereof is coupled to a pixel electrode PE. A gate of the transistor T31 is coupled to the scan line SB₁, a drain thereof is coupled to the data line DB₁, and a source thereof is coupled to a pixel electrode PE. The storage capacitor Cs30 is coupled between the pixel electrode PE and a common electrode COM. The liquid crystal capacitor is coupled between the pixel electrode PE and the common electrode COM.

In detail, the display unit 300P corresponding to a row is given as an example, and the other display units corresponding to the row operate same as the display unit 300P.

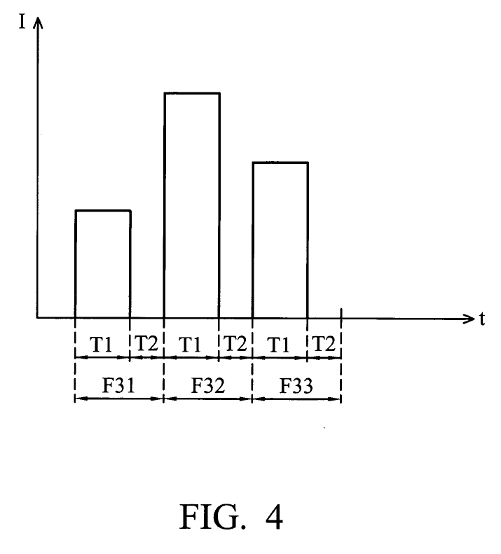

FIG. 4 depicts the relationship between time and illumination of the display unit 300P.

Referring to FIGS. 3 and 4, for the display unit 300P, a frame F31 is divided into a first period T1 and a second period T2. During the first period T1, the scan driver 301 turns on the display unit 300P through the scan line S₁ according to the scan start signal VST from the timing controller 31. When the display unit 300P is turned on, the data driver 303 outputs a corresponding video signal to the display unit 300P through the data line D₁ according to the data start signal HST from the timing controller 31, in which the video signal is related to the image to be displayed on the display unit 300P according to the video signal. Referring to FIG. 4, during period T1, illumination of the display unit 300P is maintained at a specific level according to the video signal.

During the second period T2 following the period T1, the scan driver 302 turns on the display unit 300P through the scan line S₁, according to the scan start signal VST_B from the timing controller 31. When the display unit 300P is turned on, the data driver 304 outputs a predetermined signal to the display unit 300P through the data line D₁, in which the predetermined signal relates to an image with a single gray scale value, such as a full black image or a full white image. In this embodiment, a full black image is used as an example. Referring to FIG. 4, during period T2, the illumination of the display unit 300P is maintained at a low level according to the predetermined signal. Since the scan drivers 301 and 302 operate at different times, the scan start signals VST and VST_B are different. In other words, the scan start signals VST and VST_B have different timing.

In this embodiment as shown in FIG. 3, the timing controller 31 is configured outside of the display panel 31. Through the input port 305, the timing controller 31 transmits the vertical start signal VST, the vertical start signal VST_B, and the data start signal HST respectively to the scan driver 301, the scan driver 302, and the data driver 303 of the display panel 30.

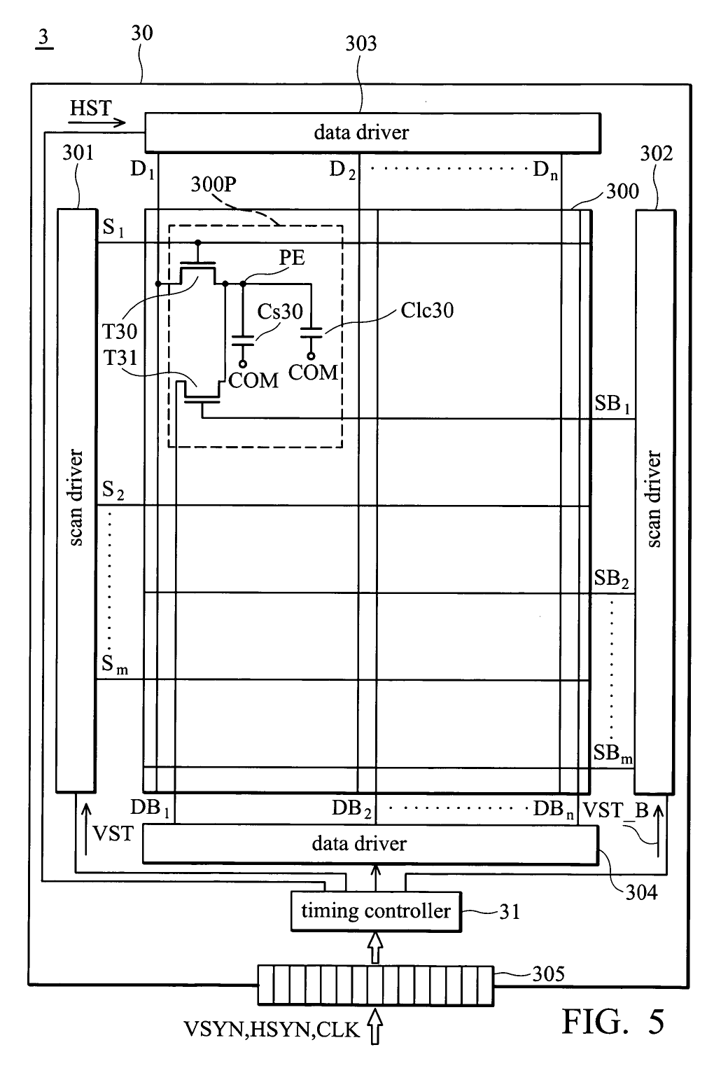

In some embodiments, as shown in FIG. 5, the timing controller 31 can be disposed on the inside of the display panel. Through the input port 305, the timing controller 31 receives the vertical synchronization signal VSYN, the horizontal synchronization signal HSYN, and the clock CLK. In other words, the display panel 30 receives the vertical synchronization signal VSYN, the horizontal synchronization signal HSYN, and the clock CLK and generates vertical start signal VST, the vertical start signal VST_B, and the data start signal HST by the timing controller 31 inside.

Accordingly, some embodiments of the display panel comprise two scan drivers and two data drivers. The scan driver 301 drives all display units of the display panel 30 with the data driver 303 to display images. The scan driver 302 drives all display units of the display panel 30 with the data driver 304 to display images with a single gray scale value, such as full black or white images. During a frame, each display unit displays an image according to a video signal first for a period and then displays a black or white image. That is, before the display device reaches a next, each display unit is switched to display a black or white image, thereby simulating the impulse-driving method used in CRT display devices. When display devices display dynamic images, no overlap of images is not occurred.

In the embodiments described above, one display unit is given as an example. In practice, all display units corresponding to a row perform the same operation, and display units operate row by row. The order of the operation is determined according system requirements. Furthermore, first and second period lengths for one frame are determined according to system requirements.

While the invention has been described in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A display panel in a display device, comprising:
a display unit;
a first scan driver for receiving a first scan start signal;
a first data driver for receiving a first data start signal and providing a video signal related to an image to the display unit according to the first data start signal when the first scan driver turns on the display unit according to the first scan start signal;
a second scan driver for receiving a second scan start signal; and
a second data driver adapted to provide a predetermined signal to the display unit when the second scan driver turns on the display unit according to the second scan start signal.

2. The display panel as claimed in claim 1, wherein the predetermined signal is indicative of a predetermined image with a single gray scale value.

3. The display panel as claimed in claim 2, wherein the predetermined image is a fully black or white image.

4. The display panel as claimed in claim 1, wherein the first and second scan start signals have different timing.

5. The display panel as claimed in claim 1, wherein during a frame, the display unit is configured to receive the video signal to display the image for a predetermined period first and then to receive the predetermined signal to display an image with a single gray scale value.

6. The display panel as claimed in claim 1, further comprising a timing controller for generating the first and second scan start signals and the first data start signal according to a vertical synchronization signal, a horizontal synchronization signal, and a clock.

7. The display panel as claimed in claim 6, wherein during a frame, the timing controller is configured to output the first scan start signal and the second scan start signal.

8. A display device for displaying an image, comprising:
a timing controller adapted to provide a first scan start signal, a second scan start signal, and a first data start signal;
a display panel comprising:
a display unit;
a first scan driver receiving the first scan start signal;
a first data driver receiving the first data start signal and providing a video signal related to the image to the display unit according to the first data start signal when the first scan driver turns on the display unit according to the first scan start signal;
a second scan driver receiving the second scan start signal; and
a second data driver providing a predetermined signal to the display unit when the second scan driver turns on the display unit according to the second scan start signal.

9. The display device as claimed in claim 8, wherein the timing controller is configured to generate the first and second scan start signals and the first data start signal according to a vertical synchronization signal, a horizontal synchronization signal, and a clock.

10. The display device as claimed in claim 9, wherein during a frame, the timing controller is configured to output the first scan start signal and the second scan start signal.

11. The display device as claimed in claim 8, wherein the timing controller is disposed in the display panel and is configured to generate the first and second scan start signals and the first data start signal according to a vertical synchronization signal, a horizontal synchronization signal, and a clock.

12. The display device as claimed in claim 11, wherein during a frame, the timing controller is configured to output the first scan start signal and the second scan start signal.

13. The display device as claimed in claim 8, wherein the predetermined signal is indicative of a predetermined image with a single gray scale value.

14. The display device as claimed in claim 13, wherein the predetermined image is a fully black or white image.

15. The display device as claimed in claim 8, wherein the first and second scan start signals have different timing.

16. The display device as claimed in claim 8, wherein during a frame, the display unit is configured to receive the video signal to display the image for a predetermined period first and then to receive the predetermined signal to display an image with a single gray scale value.
